(19) United States
(12) Patent Application Publication
(10) Pub. No.: US 2025/0178515 A1
(43) Pub. Date: Jun. 5, 2025

(54) CONFIGURABLE HEADLIGHT ASSEMBLY

(71) Applicant: Caterpillar Paving Products Inc., Brooklyn Park, MN (US)

(72) Inventors: Jarod Woodruff, Saint Francis, MN (US); Nathan Mashek, Albertville, MN (US)

(73) Assignee: Caterpillar Paving Products Inc., Brooklyn Park, MN (US)

(21) Appl. No.: 18/524,347

(22) Filed: Nov. 30, 2023

(51) Int. Cl. B60Q 1/076; B60Q 1/00

(52) U.S. Cl. CPC B60Q 1/076; B60Q 1/0023; B60Q 1/0035; B60Q 2200/36; B60Q 2800/20

(57) ABSTRACT

A configurable headlight assembly for a work machine includes at least one headlight attached via a movable assembly attached to the frame of the work machine. The movable assembly is adjustable and allows the configurable headlight assembly to move between at least two different configurations, positioning the headlight at different points in space. The movable assembly may be actuated manually or by electronic means in response to input from the operator, input from a sensor on the work machine, or by the environmental conditions surrounding the work machine.

### TECHNICAL FIELD

The present disclosure relates generally to a configurable headlight assembly and, more particularly, to a configurable headlight assembly for use with a work machine.

### BACKGROUND

Road surfaces typically include an uppermost layer of asphalt or concrete on which vehicles travel. Over time, a road surface may wear out or become damaged, for example, due to the formation of potholes or development of cracks and ruts. The damaged road surface may in turn cause damage to vehicles travelling on the road surface. The damaged road surface can be repaired locally by filling up the potholes, cracks, or ruts. It is often desirable, however, to replace the worn or damaged road surface with an entirely new road surface. This is usually accomplished by removing a layer of the asphalt or concrete from the roadway and repaving the roadway by laying down a new layer of asphalt or concrete.

A milling machine is often used to remove the layer of asphalt or concrete on the road surface. A typical milling machine includes a frame supported on wheels or tracks and includes a milling drum attached to the frame. As the milling machine is driven over the existing road surface, teeth or cutting tools on the rotating milling drum come into contact with the road surface and tear up a layer of the roadway. A milling drum chamber typically encloses the milling drum to contain the milled material. The milled material is typically transported using a conveyor system to an adjacent vehicle, which removes the material from the worksite. The conveyor system is typically able to pivot at an angle relative to the forward-travel direction of the milling machine, allowing the machine to deposit the removed material into a receptacle at an angle to, or adjacent to, the milling machine. Following the milling process, a new layer of asphalt or concrete may be applied on the milled road surface to create a new road surface.

The milling machine frame is generally supported by support units such as lift columns mounted between the frame and the tracks or wheels. Extending or retracting the lift columns raises or lowers the frame and the milling drum relative to the tracks or wheels and, consequently, relative to the ground. At least one of the support units is commonly constructed in a manner permitting it to swing or pivot between two different operating positions: a projecting position in which the track or wheel is positioned substantially outside of the boundaries of the machine frame for maximum stability, and a retracted position in which the track or wheel is positioned substantially within the boundaries of the machine frame to enable the machine to, for example, mill road surfaces close to a curb or wall. In this way, the cold planer is capable of operating in a least two different positional configurations.

Because work on a roadway may disrupt traffic, it is often desirable for crews operating mobile work machines to perform their work during times of day when roads are less frequently traveled, such as at night. Additionally, during the summer, temperatures at night are often significantly lower than those during the day, which may be preferable for the crews performing the work. Further, some projects require around-the-clock operation. Work at night, however, presents additional challenges, such as providing illumination. Further, mobile work machines such as cold planers may travel a significant distance along a road or other work site during operation, changing the environmental factors and illumination needs over the course of the project. Additionally, a cold planer is typically capable of operating in at least two different positional configurations, such as an extended position and retracted position, with each configuration requiring a different angle of illumination for operation. Further, the conveyor system on a work machine can be angled to accommodate depositing removed material into an appropriate receptacle. As that angle changes, the lighting needs may also change. Given these many variables, a single fixed illumination system may prove insufficient for the needs of the project.

Additionally, a work machine with nonconfigurable headlight assemblies in an extended position may present challenges in operation, shipping, and storage. For instance, a fixed headlight assembly that extends laterally outwardly may prevent the work machine from operating directly adjacent to a wall, building, or other obstacle. The same issue arises in shipping the work machine from one location to another, as fixed and extended headlight configurations may cause the work machine to take up more space than can fit in a storage unit for transport. Similarly, when storing the work machine in a garage or similar storage location, a fixed and extended headlight configuration can take up extra space and impact where the work machine can be parked. Thus, a fixed illumination system may be associated with several logistical problems.

U.S. Pat. No. 5,023,760 to Izuno dated Jun. 11, 1991 (“the ′760 patent”) discloses a retractable turn signal for large trucks. The system of the ′760 patent allows the turn signals protruding from the side of the truck to retract into the body of the truck, reducing drag on the vehicle and minimizing the risk of the turn signal colliding with another vehicle or other object, while still allowing the turn signal to be positioned when active to be easily seen by other drivers and pedestrians. The system of the ′760 patent provides the operator of the truck the ability to retract or extend the turn signal based on whether the operator wants to indicate the truck is turning or, if the vehicle is not turning, position the turn signal to be flush with the truck.

However, the system of the ′760 patent only relates to retractable turn signals and does not address other illumination needs of work machines.

The work machine of the present disclosure solves one or more of the problems set forth above, or other problems in the art.

### SUMMARY

In one aspect, the present disclosure is directed to a configurable headlight assembly for use with a work machine such as a milling machine. The work machine may optionally include various sensors which detect information relating to the work machine or the environment surrounding the work machine. The configurable headlight assembly includes a headlight and a movable assembly that connects the headlight to the frame of the work machine. The movable assembly allows the headlight to be moved to at least two different configurations, changing the position of the headlight. The movable assembly may also be adjusted to additional configurations, providing more than two positions for the headlight, if desired. The movable assembly may be moved manually, using a mechanism such as a slotted plate with an instrument, such as a pin, fixing the movable assembly in various configurations. The movable assembly may also be moved electronically, in response to input from the operator, the operational state of the work machine, or in response to input from a sensor on the work machine.

In another aspect, the present disclosure is related to a work machine. The work machine includes a frame and may include various sensors which detect information relating to the work machine or the environment surrounding the work machine. Additionally, the work machine is equipped with a configurable headlight assembly, which includes a headlight and a movable assembly that connects the headlight to the frame of the work machine. The movable assembly allows the headlight to be moved to at least two different configurations, changing the position of the headlight. The movable assembly may also be adjusted to additional configurations, providing more than two positions for the headlight, if desired. The movable assembly may be moved manually, using a mechanism such as a slotted plate with an instrument, such as a pin, fixing the movable assembly in various configurations. The movable assembly may also be moved electronically, in response to input from the operator, the operational state of the work machine, or in response to input from a sensor on the work machine.

In yet another aspect, the present disclosure relates to a method of adjusting the position of a configurable headlight assembly of a work machine. The work machine includes a frame and may include various sensors which detect information relating to the work machine or the environment surrounding the work machine. The work machine is also equipped with a configurable headlight assembly which includes a headlight and a movable assembly connecting the headlight to the frame of the work machine. The method includes selecting a headlight connected to the frame of the work machine by a movable assembly. The method also includes moving the movable assembly attaching the selected headlight from one configuration to another configuration. Moving the movable assembly can be accomplished manually using a mechanism such as a slotted plate with an instrument, such as a pin, fixing the movable assembly in various configurations. The movable assembly may also be moved electronically, in response to input from the operator, the operational state of the work machine, or in response to input from a sensor on the work machine.

### BRIEF DESCRIPTION OF DRAWINGS

FIG. 1 is a side-view illustration of an exemplary work machine equipped with a configurable headlight assembly.

FIG. 2 is a top view of the work machine in FIG. 1 with a conveyor and headlight assemblies in multiple configurations.

FIG. 3 depicts a configurable headlight assembly, such as shown in association with the work machine of FIGS. 1 and 2.

FIG. 4 shows a first configuration and a second configuration of the configurable headlight assembly of FIG. 3.

### DETAILED DESCRIPTION

This disclosure relates to work machines. Example of such work machines are milling machines or cold planers, which are work machines used to remove layers of hardened asphalt, cement, or other road surfaces from an existing roadway or to remove non-road surface material from the ground, such as in a mining operation. This disclosure may also be relevant to other work machines, such as pavers, and others.

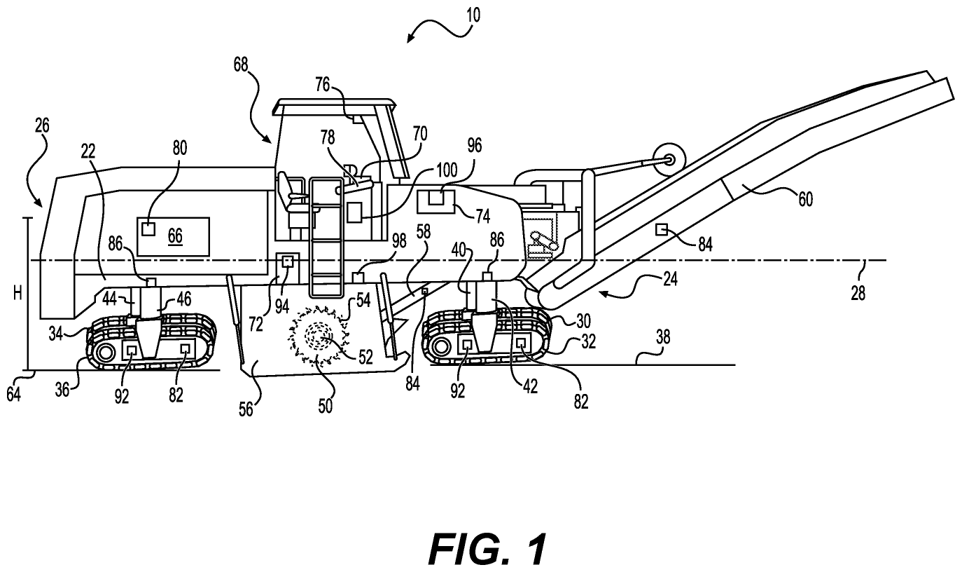

FIG. 1 illustrates an exemplary milling machine 10, which as shown may be a cold planer, which may also be referred to as a cold milling machine, a scarifier, a profiler, etc. Milling machine 10 includes frame 22, which extends from first end 24 to second end 26 disposed opposite first end 24. In some exemplary embodiments, first end 24 is a front end and second end 26 is a rear end of frame 22. Frame 22 may have any shape (e.g. rectangular, triangular, square, etc.) and may have a longitudinal axis 28 extending in a generally forward-rearward travel direction of milling machine 10.

Frame 22 is supported on one or more propulsion devices. For example, as illustrated in FIG. 1, frame 22 is supported on propulsion devices 30, 32, 34, 36. Propulsion devices 30, 32, 34, 36 may be equipped with electric or hydraulic motors which impart motion to propulsion devices 30, 32, 34, 36 to help propel milling machine 10 in a forward or rearward direction. As illustrated in FIG. 1, propulsion devices 30, 32, 34, 36 may take the form of tracks, which may include, for example, sprocket wheels, idler wheels, or one or more rollers that may support a continuous track. It is contemplated, however, that propulsion devices 30, 32, 34, 36 of milling machine 10 may take the form of wheels or other ground engaging units capable of propelling milling machine 10. It is also contemplated that propulsion devices 30, 32, 34, 36, when in the form of wheels, may also include one or more tires.

Propulsion devices 30 and 32 may be located adjacent first end 24 of frame 22 and tracks 34 and 36 may be located adjacent second end 26 of frame 22. Propulsion device 30 may be spaced apart from propulsion device 32 along a width direction of frame 22. Likewise, propulsion device 34 may be spaced apart from propulsion device 36 along a width direction of frame 22. In one exemplary embodiment as illustrated in FIG. 1, propulsion device 30 is a left front track, propulsion device 32 is a right front track, propulsion device 34 is a left rear track, and propulsion device 36 is a right rear track. Some or all of propulsion devices 30, 32, 34, 36 may also be steerable, allowing milling machine 10 to be turned towards the right or left during a forward or rearward motion on ground surface 38. Although milling machine 10 in FIG. 1 has been illustrated as including four propulsion devices 30, 32, 34, 36, it is contemplated that in some exemplary embodiments, milling machine 10 may have only one rear propulsion device 34 or 36, which may be located generally centered along a width of frame 22.

Frame 22 may be connected to propulsion devices 30, 32, 34, 36 by one or more leg columns 40, 42, 44, 46. For example, as illustrated in FIG. 1, frame 22 is connected to left front propulsion device 30 via leg column 40 and to right front propulsion device 32 via leg column 42. Likewise, frame 22 is connected to left rear propulsion device 34 via leg column 44 and to right rear propulsion device 36 via leg column 46. One or more of leg columns 40, 42, 44, 46 may be height adjustable such that a height of frame 22 relative to one or more of propulsion devices 30, 32, 34, 36 may be increased or decreased by adjusting a length of one or more of leg columns 40, 42, 44, 46, respectively. It will be understood that adjusting a height of frame 22 relative to one or more of propulsion devices 30, 32, 34, 36 would also adjust a height of frame 22 relative to ground surface 38 on which propulsion devices 30, 32, 34, 36 may be supported.

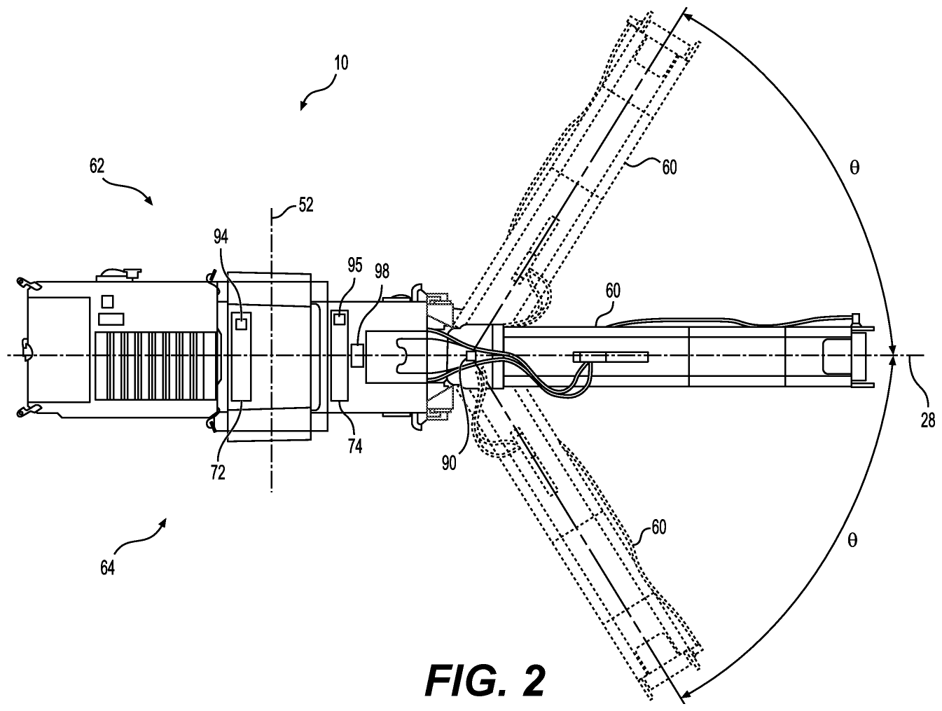

Milling machine 10 may include milling drum 50, which is attached to frame 22 between front end 24 and rear end 26. Milling drum 50 may extend along transverse axis 52 (see also e.g., FIG. 2) of frame 22. Milling drum 50 may include cutting tools 54, such as cutting teeth, that may be configured to cut into and tear up a predetermined thickness of a roadway or the ground. A height of milling drum 50 relative to the ground surface 38 may be adjusted by adjusting a height of one or more leg columns 40, 42, 44, 46. As milling drum 50 rotates, cutting tools 54 of milling drum 50 may come into contact with the ground or road surface 38, thereby tearing up or cutting the ground or road surface 38. Milling drum 50 may be enclosed within drum chamber 56 which may help contain the material removed by cutting tools 54 from the ground or road surface 38. Milling machine 10 may include one or more conveyors 58, 60, which may help transport the material removed by milling drum 50 to an adjacent vehicle, such as a dump truck, or other receptacle.

As illustrated in FIG. 2, at least conveyor 60 may be rotated or slewed towards left side 62 or right side 64 of milling machine 10. It is to be understood that left side 62 and right side 64 are determined relative to a forward movement direction of milling machine 10. As illustrated in FIG. 2, conveyor 60 may be slewed by slew angle θ relative to longitudinal axis 28 on either side (e.g., left side 62 or right side 64) of longitudinal axis 28. Slewing conveyor 60 in this manner allows material removed by milling drum 50 from ground surface 38 to be directed to a dump truck that may travel alongside milling machine 10 on either left side 62 or right side 64 of milling machine 10.

Returning to FIG. 1, milling machine 10 includes engine 66, which may be attached to frame 22. Engine 66 may be any suitable type of internal combustion engine, such as a gasoline, diesel, natural gas, or hybrid-powers engine. It is contemplated, however, that in some exemplary embodiments, engine 66 may be driven by electrical power. Engine 66 may be configured to deliver rotational power output to one or more hydraulic motors associated with propulsion devices 30, 32, 34, 36, to milling drum 50, and to the one or more conveyors 58, 60. Engine 66 may also be configured to deliver power to operate one or more other components or accessory devices (e.g. pumps, fans, motors, generators, belt drives, transmission devices, etc.) associated with milling machine 10.

Milling machine 10 includes operator platform 68, which is attached to frame 22. In some exemplary embodiments, operator platform 68 may be in the form of an open-air platform that may or may not include a canopy. In other exemplary embodiments, operator platform 68 may be in the form of a partially or fully enclosed cabin. As illustrated in FIG. 1, operator platform 68 is located at a height “H” above ground surface 38. In some exemplary embodiments, height H may range between about 2 ft to 10 ft above ground surface 38. Operator platform 68 may include operator console 70. Operator console 70 may include one or more controls or input devices, which may be used by an operator to operate or control milling machine 10. The one or more input devices may take the form of buttons, switches, sliders, levers, wheels, touch screens, or other input/output or interface devices.

Milling machine 10 also includes fuel tank 72 and water tank 74. In one exemplary embodiment as illustrated in FIG. 1, fuel tank 72 is located under operator platform 68 and water tank 74 is located in front of operator platform 68. It is to be understood, however, that fuel tank 72 and water tank 74 may be located anywhere else on milling machine 10.

Milling machine 10 may also include alarm device 76 that may be located in operator platform 68. In one exemplary embodiment alarm device 76 is an audible alarm or a speaker configured to generate an audible alarm or audible message. Additionally or alternatively, alarm device 76 may include one or more visual indicators (e.g., lights or displays) included on operator console 70 in operator platform 68. It is further contemplated that in some embodiments, alarm device 76 may additionally or alternatively include display device 78 on operator console 70. Display device 78 may include one or more of a cathode ray tube, a liquid crystal display, a light emitting diode display, a touch-screen display or any other type of display device configured to display one or more symbols, or textual or graphical displays to an operator of milling machine 10.

Milling machine 10 may be equipped with numerous sensors, some of which may be configured to determine operational parameters (e.g., engine speed, ground speed, milling drum speed, conveyor speed, acceleration, temperature, pressure, etc.) of milling machine 10. For example, milling machine 10 may be equipped with engine speed sensor 80, ground speed sensor 82, and conveyor speed sensor 84. Engine speed sensor 80 may be configured to measure, for example, a rotational speed of engine 66 (e.g., in revolutions per minute or rpm). Ground speed sensor 82 may be configured measure a speed of milling machine 10 in the forward or rearward directions relative to ground surface 38 (e.g., in m/s, Km/h, or mph). In one exemplary embodiment, each of propulsion devices 30, 32, 34, 36 may be equipped with one or more ground speed sensors 82 configured to determine a speed of each of propulsion devices 30, 32, 34, 36 relative to ground surface 38. It is contemplated, however, that ground speed of milling machine 10 or 20 may be determined in other ways, for example, using GPS sensors, inertial sensors, flow rate or pressure of hydraulic fluid in hydraulic motors associated with propulsion devices 30, 32, 34, 36, etc.

Each of conveyors 58 and 60 may be equipped with conveyor speed sensor 84, which may be configured to determine a linear speed of conveyors 58, 60 (in m/s or ft/s). It is also contemplated that in some embodiments, conveyor speed sensor 84 may be a rotational speed sensor associated with one or more rollers configured to move conveyors 58, 60, and the linear speed of conveyors 58, 60 may be determined from the measured rotational speed of the rollers. Sensors 80, 82, 84, etc. may be operational sensors configured to measure operational parameters associated with operation of engine 66, propulsion devices 30, 32, 34, 36, conveyors 58, 60, etc. It is contemplated that milling machine 10 may include many additional operational sensors, for example, milling drum speed sensors, temperature sensors to measure a temperature of an engine coolant, temperature sensors to measure temperatures of cutting teeth 54, or other sensors to measure flow rate, pressure, or temperature of hydraulic fluid being supplied to various implements of milling machine 10, etc.

Milling machine 10 may also include one or more configuration sensors that may be configured to measure configuration parameters associated with milling machine 10. Configuration parameters may provide information regarding a position or configuration of one or more components of milling machine 10. For example, configuration parameters may include height of one or more of leg columns 40, 42, 44, 46, slew angle of conveyor 60 relative to axis 28, steering angle of one or more of propulsion devices 30, 32, 34, 36, level of fuel in fuel tank 72, level of water in water tank 74, position of one or more optionally attached implements (e.g., additional water tanks, pumps, generators, external sensors, structural beams, etc.). As illustrated in FIGS. 1 and 2, for example, milling machine 10 includes one or more height sensors 86, slew angle sensor 90 (see FIG. 2), one or more steering angle sensors 92, fuel level sensor 94, and water level sensor 96. It is contemplated that milling machine 10 may include other configuration sensors (e.g., distance sensors, weight sensors, etc.).

Height sensor 86 may be configured to determine a height of frame 22 relative to ground surface 38 adjacent leg column 40, 42, 44, or 46. Height sensor 86 may include one or more of laser sensors, ultrasonic sensors, capacitive, or inductive sensors capable of measuring a length of one or more of leg columns 40, 42, 44, or 46. A height of frame 22 may be determined based on the measured lengths of the one or more leg columns 40, 42, 44, or 46 and geometric information regarding frame 22 or one or more of propulsion devices 30, 32, 34, or 36. It is also contemplated that in some embodiments, height sensors 86 may include one or more ultrasonic sensors configured to directly measure a height of frame 22 relative to ground surface 38. In other exemplary embodiments, height sensors 86 may include one or more of GPS sensors, inertial sensors, or other position sensors configured to determine a height of frame 22 relative to ground surface 38.

Slew angle sensor 90 may be configured to measure slew angle θ of conveyor 60 relative to longitudinal axis 28. In one embodiment, slew angle sensor 90 includes a rotational sensor disposed at or adjacent to a pivotable connection between conveyor 60 and frame 22. Slew angle sensor 90 may be configured to measure an amount of rotation of conveyor 60 in a leftward or rightward transverse direction (e.g., transverse to longitudinal axis 28). One or more of propulsion devices 30, 32, 34, 36 may include steering angle sensors 92. Steering angle sensors 92 may be configured to measure an angle of rotation of propulsion devices 30, 32, 34, or 36 in a transverse direction relative to longitudinal axis 28.

Fuel level sensor 94 may be configured to measure a height of fuel relative to a base of fuel tank 72. It is also contemplated that fuel level sensor 94 may be configured to measure an inclination of a free surface of the fuel in fuel tank 72 relative to the base of fuel tank 72. In some embodiments, fuel level sensor 94 may be configured to determine a volume of fuel in fuel tank 72 and a height of the fuel relative to the base of fuel tank 72 may be determined based on the measured volume of fuel and geometrical characteristics of fuel tank 72. Water level sensor 96 may be configured to measure a height of water in water tank 74 relative to a base of water tank 74. In some embodiments, water level sensor 96 may be configured to determine a volume of water in water tank 74 and a height of the water relative to the base of water tank 74 may be determined based on the measured volume of water and geometrical characteristics of water tank 74. It is also contemplated that water level sensor 96 may be configured to measure an inclination of a free surface of the water in water tank 74 relative to the base of fuel tank 72.

Milling machine 10 may include controller 100, which may be configured to receive inputs, data, or signals from the one or more input devices, sensors 80, 82, 84, 86, 90, 92, 94, 96, 98, etc., or other sensors associated with milling machine 10. Controller 100 may include or be associated with one or more processors, memory devices, or communication devices. Controller 100 may embody a single microprocessor or multiple microprocessors, digital signal processors (DSPs), application-specific integrated circuit devices (ASICs), etc. Numerous commercially available microprocessors may be configured to perform the functions of controller 100. Various other known circuits may be associated with controller 100, including power supply circuits, signal-conditioning circuits, and communication circuits, etc.

The one or more memory devices associated with controller 100 may store, for example, data or one or more control routines, instructions, mathematical models, algorithms, machine learning models, etc. The one or more memory devices may embody non-transitory computer-readable media, for example, Random Access Memory (RAM) devices, NOR or NAND flash memory devices, and Read Only Memory (ROM) devices, CD-ROMs, hard disks, floppy drives, optical media, solid state storage media, etc. Controller 100 may execute one or more routines, instructions, mathematical models, algorithms, or machine learning models stored in one or more memory devices to generate and deliver one or more command signals to one or more of propulsion devices 30, 32, 34, 36, engine 66, milling drum 50, conveyors 58, 60, or other implements and components of milling machine 10.

Milling machine 10 also includes at least one configurable headlight assembly 110. The configurable headlight assembly includes a headlight 120 which provides illumination at an adjustable angle generally in front of milling machine 10. In a preferred embodiment, milling machine 10 is equipped with a pair of configurable headlight assemblies 110. One headlight assembly is attached to frame 22 at the front first end 24 of the left side 62 of milling machine 10 using bracket 112, facing in the forward travel direction of milling machine 10. The other headlight assembly 110 is attached to frame 22 at the front first end 24 of the right side 64 of milling machine 10 using bracket 112, also facing in the forward travel direction of milling machine 10. While the preferred embodiment contemplates the use of two configurable headlight assemblies, those skilled in the art may equip a single configurable headlight assemble, or more than two configurable headlight assemblies 110, to milling machine 10. Those skilled in the art may also combine the use of configurable headlight assemblies 110 with conventional, fixed headlight assemblies known in the prior art. Further, those skilled in the art are also capable of attaching configurable headlight assemblies 110 to other parts of milling machine 10, directing illumination towards the rear, sides, or other angles relative to milling machine 10.

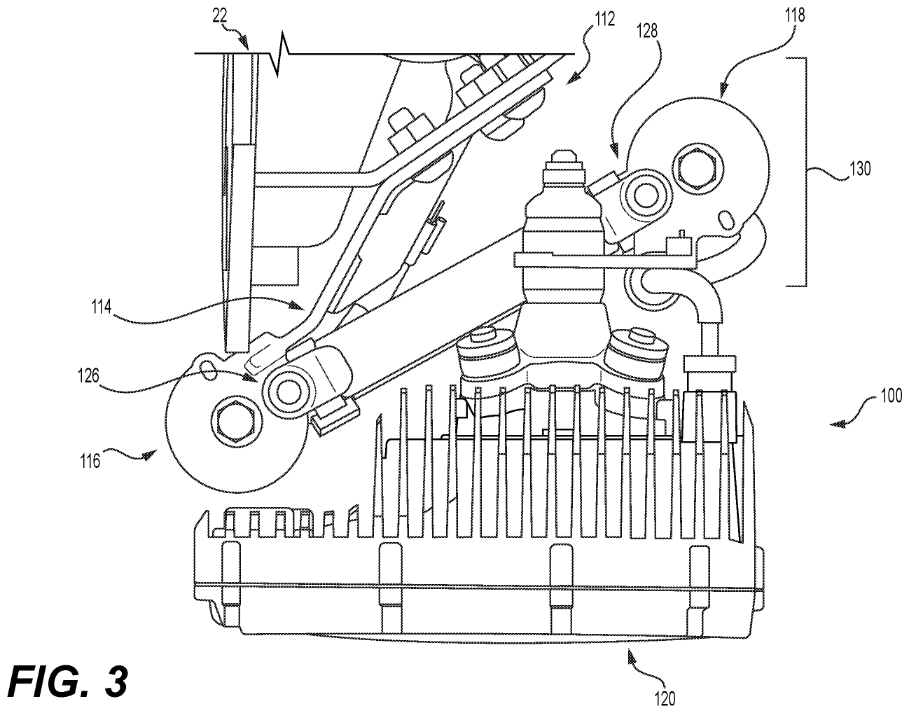

FIG. 3 depicts an example of configurable headlight assembly 110. In this embodiment, the headlight assembly consists of headlight 120 and movable assembly 130. In this embodiment, movable assembly 130 consists of bracket 112, arm 114, and pivot points 116 and 118. Bracket 112 attaches to frame 22 of milling machine 10. Extending from bracket 112 is arm 114, which terminates in headlight 120. Arm 114 also includes pivot points 116 and 118, which permit arm 114 and headlight 120 to rotate to different configurations. As an example, pivot points 116 and 118 may be slotted pivot plates used in conjunction with pins 126 and 128, but could also consist of other forms of articulation known in the art.

While this preferred embodiment consists of a single headlight 120 per configurable headlight assembly 110, additional headlights 120 could be attached to the configurable headlight assembly 110. Additionally, while a single bracket 112 is depicted in the preferred embodiment, additional brackets or other connecting devices may be used to attach the configurable headlight assembly 110 to frame 22. Alternatively, headlight assembly 110 could directly extend from frame 22. Further, those skilled in the art would be capable of including additional arms 114 or pivot points 116 and 118 to the movable assembly 130, allowing for different configurations positioning the headlight 120 horizontally or vertically in space.

Headlight 120 can be of any suitable type or design of artificial lighting. For example, headlight 120 can be incandescent lamps in which an electric current is applied to a filament that glows and emits visible light as a result. Another example is a light emitting diode (LED) in which the light source is a semiconductor material, specifically a diode, that emits light when a current is applied to it. Other examples include gas-discharge or vapor lamps in which an electric current is discharged through an entrapped gas causing it to ionize and discharge light. Moreover, headlight 120 can be provide in different colors, intensities, and foci. The arrangement and direction of various headlights 120 about milling machine 10 may be subject to industry or government standards.

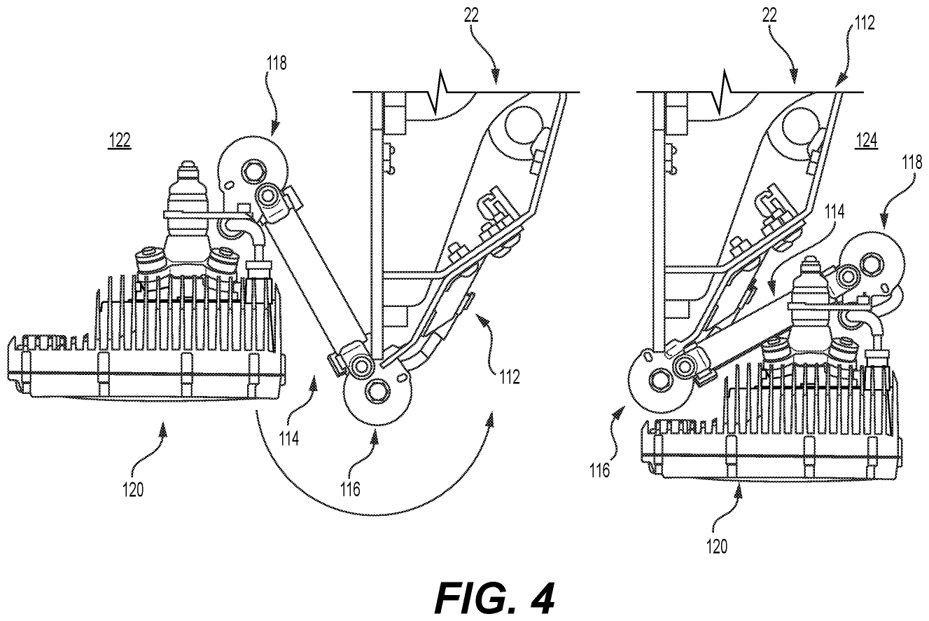

FIG. 4 shows an exemplary configurable headlight assembly 110 attached to frame 22 of milling machine 10 via bracket 112. The exemplary headlight assembly 110 is depicted in an extended first configuration 122 and a retracted second configuration 124. Configurable headlight assembly 110 shifts from first configuration 122 to second configuration 124 by rotating arm 114 at pivot point 116. As depicted in FIG. 4, the position of arm 114 at pivot point 116 is fixed by inserting pin 126 to lock the rotation at pivot point 116. Headlight 120 is also rotated at pivot point 118 to the desired angle for illumination. As depicted in FIG. 4, the position of headlight 120 is fixed by inserting pin 128 to lock the rotation at pivot point 118. Pins 126 and 128 may, for example, be spring-loaded pins. Those skilled in the art would be aware of other means of fixing rotation at pivot points 116 and 118 via mechanical or electrical means. While the preferred embodiment depicts a first configuration 122 and a second configuration 124, additional configurations of headlight assembly 110 may be achieved by fixing the pivot points 116 and 118, or by fixing additional pivot points, in different positions.

Headlight assembly 110 may be adjusted from a first configuration 122 to a second configuration 124 manually, by physically adjusting arm 114 at pivot points 116 and 118. Those skilled in the art would know that the same principle applies if additional configurations are desired by including additional arms or pivot points or by locking the pivot points 116 and 118 in different positions.

Headlight assembly 110 can also be adjusted from a first configuration 122 to a second configuration 124 through electronic means. For example, this can be accomplished by inputting the desired configuration at operator console 70. A similar signal could also be input via a remote-control device. Once controller 100 receives the signal to adjust the headlight assembly 110, it may send a signal to actuators capable of rotating arm 114 and headlight 120 at pivot points 116 and 118, respectively. The same process can be applied by those skilled in the art to achieve additional headlight assembly 110 configurations via additional pivot points or arms. The status of the vehicle, as detected by sensors 78, 80, 82, 84, 86, 90, 92, 94, 96, or 98, or by any other sensor sending a signal to controller 100, may also trigger headlight assembly 110 to change configurations in response to specified input from said sensor. For example, when the controller 100 determines that the milling is being shut off, it may automatically request that headlight assembly 110 be set to a retracted position 124.

### INDUSTRIAL APPLICABILITY

The disclosed configurable headlight assembly 110 may be used with any work machine where variably positioned illumination may be required or preferred. The disclosed assembly allows the operator to configure the position and angle of a light source on a work machine. This assembly can be useful for projects that must be performed during night-time hours or in other low-light worksites, such as at mining sites. By improving the lighting of a work site, the configurable headlight assembly 110 increases the visibility of a designated area.

A particular use case arises when a milling machine 10 is in operation is in operation, using its milling drum 50 to remove material from a ground surface 38. As the material is removed from the ground surface 38, it moves along conveyors 58 and 60 to be deposited in a receptacle, such as a dump truck, bin, or other location for transport or storage. If the receptacle is positioned directly in front of milling machine 10, conveyor 60 does not need to rotate and the material can be deposited into the receptacle straight ahead. Conditions on site do not always permit this, however, and the milling machine 10 may need to deposit material to a receptacle located at an angle to its longitudinal axis 28 or even directly to side of milling machine 10. FIG. 2 illustrates different exemplary configurations of conveyor 60 in relation to milling machine 10. As conveyor 60 rotates to a different position, configurable headlight assembly 110 can also be adjusted from a first configuration 122 to a second configuration 124 provided increased lighting on conveyor 60, as depicted in FIG. 2 in dashed lines. Configurable headlight assembly 110 can be further adjusted, manually or in real time via input signals at controller 100, as conveyor 60 moves, ensuring maximum visibility.

Another example of the practical applicability of the disclosed assembly occurs with milling machine 10 is required to remove ground surface 38 directly adjacent to a wall, fence, building, or other obstacle. In this situation, if the milling machine 10 was equipped with a fixed, extended headlight assembly, the milling machine 10 may be unable to work the ground surface 38 with its milling drum 50 without crashing headlight 120 into the wall or obstacle. Utilizing configurable headlight assembly 110, however, allows the operator to adjust the configurable headlight assembly 110 from an expanded configuration 122 to a retracted configuration 124, allowing the milling machine 10 to operate flush to the wall or obstacle. Once the work near the obstacle is complete, the configurable headlight assembly 110 can be adjusted back to an extended configuration 124 to provide better worksite illumination or comply with industry or governmental standards or requirements.

Because configurable headlight assembly 110 can be configured to respond to input from various sensors on milling machine 10, including, but not limited to sensors 78, 80, 82, 84, 86, 90, 92, 94, 96, or 98, certain changes to the position of the configurable headlight assembly 110 can be automated. For example, input from slew angle sensor 90 could be sent to controller 100, which in turn signals actuators to adjust configurable headlight assembly 110 in response to the input data, allowing the configurable headlight assembly 110 to track the conveyor 60 automatically as conveyor 60 is adjusted by the operator. Similar automatic configurations could arise from, for example, height data from height sensor 86, steering angle sensor 92, or slope sensor 98 to ensure that the configurable headlight assembly 110 is positioned to provide optimal illumination of the worksite in front of milling machine 10. This allows the operator to focus on driving the milling machine 10 and operating the milling drum 50 and conveyor 60 without the need to devote attention to lighting. These implementations of sensor data are merely exemplary, and those skilled in the art would be able to apply these principles to a variety of situations and inputs.

Additionally, use of the disclosed configurable assembly provides practical benefits when it comes to transporting and storing milling machine 10. Given the size of milling machines, it can be difficult to transport them in a standard truck or train car. Compounding this difficulty is the lighting apparatus used by a milling machine 10. In order to comply with some regulations, the lighting for a milling machine 10 must be set out wider than the width of frame 22. If that lighting is fixed in place, it takes up additional space during shipping, which may limit the amount of product shipped or increase the cost of shipment. A milling machine 10 using a configurable headlight assembly 110, however, can avoid this issue by simply adjusting the configurable headlight assembly 110 into retracted configuration 124 during transit. If desired, configurable headlight assembly 110 can then be set to a different configuration after arriving at its destination. Similar benefits arise relating to storing milling machine 10. With the disclosed ability to adjust headlight configurations, milling machine 10 can more easily fit into a narrow garage, parking space, alcove, or other confined space without sacrificing any of the functionality provided by the expanded configuration 122.

Although specific preferred embodiments of the invention are described in detail above, in light of the overall disclosure, one skilled in the art may conceive modifications and variations not particularly addressed in the above description. For example, many specifically described structural components and arrangements of such components may be substituted by other components and arrangements without deviating from the described invention. Other aspects, objects, and advantages of this invention can be obtained from a study of the drawings, the disclosure, and the appended claims. It is intended that the specification and examples be considered as exemplary only, with the true scope of the disclosure being indicated by the following claims and their equivalents.

1. A configurable headlight assembly for a work machine comprising:
at least one headlight;
a movable assembly attached to the frame of the work machine supporting the at least one headlight and configured to connect the headlight to the frame of the work machine; and
a mechanism for adjusting the movable assembly between at least two configurations.

2. The configurable headlight assembly of claim 1, wherein the mechanism for adjusting the movable assembly is a slotted pivot plate with an instrument inserted into a slot corresponding to one of the at least two configurations to position the movable assembly in one of the at least two configurations.

3. The configurable headlight assembly of claim 2, wherein the instrument inserted is a spring-loaded pin.

4. The configurable headlight assembly of claim 1, wherein the mechanism includes an electronic actuator configured to move the movable assembly.

5. The configurable headlight assembly of claim 4, wherein the actuator actuates in response to input from the operator of the work machine.

6. The configurable headlight assembly of claim 4, wherein the actuator includes a motor for driving the movement of the movable assembly in response to an operational state of the work machine.

7. The configurable headlight assembly of claim 4, wherein the actuator actuates in response to input from a sensor of the work machine.

8. A work machine comprising:
At least one headlight;
A frame;
A moveable assembly supporting the at least one headlight and connecting the headlight to the frame of the work machine; and
A mechanism for adjusting the movable assembly between at least two configurations.

9. The work machine of claim 8, wherein the mechanism for adjusting the movable assembly includes a slotted pivot plate with an instrument inserted into a slot corresponding to one of the at least two fixed positions to position the movable assembly in one of the at least two fixed positions.

10. The work machine of claim 9, wherein the is a spring-loaded pin.

11. The work machine of claim 8, wherein the mechanism for the movable assembly is an electronic actuator is configured to move the movable assembly.

12. The work machine of claim 11, wherein the electronic actuator actuates in response to input from the operator of the mobile work machine.

13. The work machine of claim 11, wherein the actuator includes a motor for driving the movement of the movable assembly in response to an operational state of the work machine.

14. The work machine of claim 11, wherein the actuator actuates in response to input from a sensor of the work machine.

15. A method for adjusting at least one headlight of a mobile work machine having a headlight, a frame, and a movable assembly connecting the headlight to the frame, the method comprising:
a. Selecting at least one headlight connected to the mobile work machine by a movable assembly;
b. Actuating a mechanism for adjusting the movable assembly connected to the selected headlight; and
c. Using the mechanism for adjusting the movable assembly connected to the second headlight from at least one configuration to a second configuration.

16. The method of claim 15, wherein the mechanism for adjusting the movable assembly is a slotted pivot plate with an instrument inserted into a slot corresponding to one of the at least two configurations to select one of the at least two configurations of the headlight.

17. The method of claim 16, wherein the instrument inserted into a slot of the slotted pivot plate detent is a spring-loaded pin.

18. The method of claim 15, wherein the mechanism for the movable assembly is an electronic actuator is configured to move the movable assembly.

19. The method of claim 18, wherein the electronic controller actuates in response to input from the operator of the mobile work machine.

20. The method of claim 18, wherein the actuator actuates in response to input from a sensor of the work machine.
